(19) United States
(12) Patent Application Publication
(10) Pub. No.: US 2006/0027602 A1
(43) Pub. Date: Feb. 9, 2006

(54) Holder for containers containing viscous products

(76) Inventor: Zdravko Omrcen, Split (HR)

Correspondence Address: KATHLEEN T. PETRICH;STOKES LAWRENCE, P.S., 800 FIFTH AVENUE, SUITE 4000, SEATTLE, WA, 98104-3179, US

(21) Appl. No.: 11/250,106

(22) Filed: Oct. 13, 2005

(30) Foreign Application Priority Data
Mar. 25, 2004 (WO) PCT/HR04/00008
Apr. 14, 2003 (HR) P20030285A

(51) Int. Cl. B67D 5/06

(52) U.S. Cl. 222/185.1

(57) ABSTRACT

A holder of containers containing viscous matters in two basic embodiments, one with a solid body and one with an at least partially hollow body. Each embodiment holder has an opening of a size to accommodate a neck of a container containing viscous liquids. In use, the neck is inserted within the opening such that the container is positioned upside down. The holder is either seated or affixed, such as by suction, to a base, thereby allowing the holder to hold the container upside down with the neck inserted into the holder opening. In the solid body embodiment, the body's wide lower portion and weight aid in keeping the holder seated relative to the base. In the hollow body embodiment, the holder has a wide opening at its bottom portion and a fitting to which a pneumatic sucker, or suction device, is fitted. The suction device fixes the holder to the base via a suction seal between the suction device and the base.

### RELATED APPLICATION

The present application claims priority to PCT/HR2004/000008, filed Mar. 25, 2004, which claims priority to Croatian Patent Application No. P20030285A, filed Apr. 14, 2003.

### TECHNICAL FIELD

The invention relates generally to holders for containers. Particularly, the present invention relates to holders for containers containing a viscous matter with the containers having necks that are inserted or partially inserted into the holder. The holder also forms the bottle (or container) closure. In the International Patent Classification it is classified as section B—Performing Operations, subsection B 65 D—Containers and closures therefore.

### BACKGROUND OF THE INVENTION

Holders intended for containers containing viscous matters that would enable usage of the container's entire content and avoid clogging of the container neck are unknown. Similar closures for bottles containing liquids are being widely applied in bars, such as for pouring of spirits. Many bars contain liquor bottles turned upside down above the bar where the closure on the bottles also serves to measure or dose the amount of liquor added to a drink. The closure is opened by pressure of the glass, letting into the glass an exact quantity of the liquid in the bottle.

However, in the cabinet-making industry, where various viscous glues filled into various vessels are being used daily, there is a need for a holder that allows multiple access to the container without clogging the container with dried out viscous matter.

While the container is full, there is no problem about pressing the contents out. However, as glue is used, and the container is kept upright, the glue requires more time to exit the container. In most cases, the remaining glue dries and solidifies in the outlet opening, thus, forming a clog and preventing the glue from coming out. In production, this causes certain idle time and is to be avoided.

The solution is a holder that would hold the container upside down once its contents have been accessed. The holder will also make the container closure. The holder can also have an added vacuum sucker (suction device) that will further seat or fix the holder against a flat base. This is needed because all containers containing viscous matters, once opened, are normally kept upside down so that the contents are ready for quick and repeated use at all times and that the entire contents can be used.

### SUMMARY OF THE INVENTION

The essence of the invention is a holder of containers containing viscous matters, such as glues, household products, foodstuffs, and medicines. At the holder's upper end is a narrow opening for inserting the container's neck. The bottom end, facing a base to which the bottom of the holder is seated or fixed, may be a solid bottom or having an opening within which a pneumatic sucker, or suction device, is fitted in order to fix the suction device to the flat base. In this way, the container, which when inserted into the seated or fixed holder, is positioned upside down and cannot readily turn over. The container can be inserted into and removed from the holder many times, without the risk of the viscous contents drying and/or clogging within the container's neck. Such holders decrease the loss of time, conserve the viscous contents, and increases tidiness of the working place.

The holder's outer and inner shapes, as well as the container-neck opening can be designed in various ways.

These and other advantages will become more apparent upon review of the Drawings, the Best Mode for Carrying Out the Invention, and the Claims.

### BRIEF DESCRIPTION OF THE DRAWINGS

Like reference numerals are used to designate like parts throughout the several views of the drawings, wherein:

FIG. 1 is a front view of a holder of a first embodiment of the present invention;

FIG. 2 is a top view of FIG. 1;

FIG. 3 is a bottom view of FIG. 1;

FIG. 4 is a cross-section view taken across lines A-A of FIG. 1;

FIG. 5 is a view like FIG. 4, except illustrating a second embodiment of the present invention having a partially hollow holder with a fitting in which a pneumatic sucker, or suction device, is fitted;

FIG. 6 is a front view of the second embodiment of FIG. 5 and showing a suction device fitted to the fitting of FIG. 5 and with a bottom portion of the suction device extending below the bottom of the holder;

FIG. 7 is a bottom view of FIG. 6;

FIG. 8 is a cross-section view like FIG. 5, except illustrating the fitted pneumatic suction device of FIG. 6;

FIG. 9 is a front view of the holder of FIG. 1 accepting a container with its neck partially inserted into the holder;

FIG. 10 is a cross-section view of FIG. 9;

FIG. 11 is a front view like that of FIG. 9, except with the holder of FIG. 6; and

FIG. 12 is a cross-section view of FIG. 11.

### BEST MODE FOR CARRYING OUT THE INVENTION

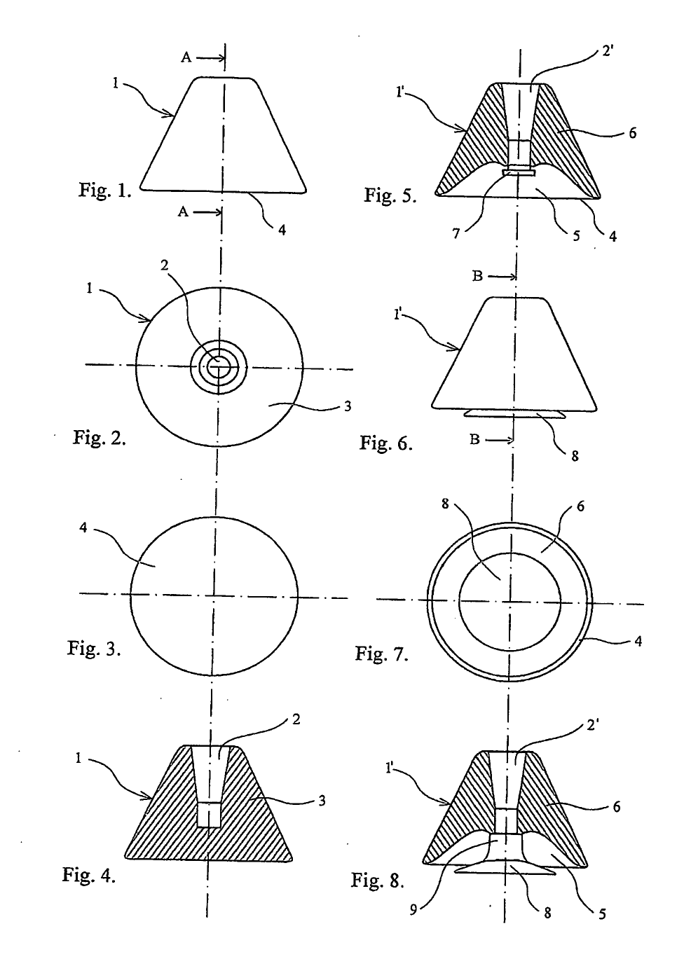

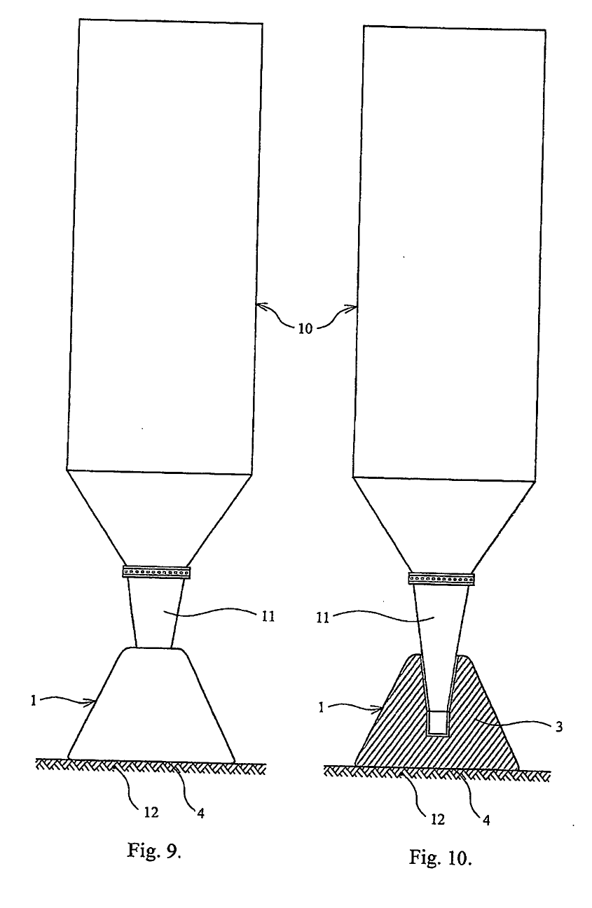

Referring to FIGS. 1-12, the present invention relates to a holder 1, 1′ that holds or contains a container 10 having a neck 11, which is inserted, at least partially, into an opening 2, 2′ of holder 1, 1′. Container 10 contains viscous matters, such as glue or the like.

Referring particularly to FIGS. 1-4, a first embodiment holder 1 is illustrated. Holder 1 comprises a body 3 that is made of a solid material. At its upper end body 3 defines a narrow opening 2 into which neck 11 of the container 10 is inserted. The shape of the opening conforms to the shape of the neck, which may vary.

Holder 1 has a flat or planar bottom 4. In use, holder 1 is placed on a base 12 by its flat bottom 4. By its wide bottom and its weight, the holder 1 holds the container upright and enables repeated removal and insertion of the container neck 11 into holder opening 2. The holder also forms a closure to container 10 when the neck is inserted into opening 2.

Referring now to FIGS. 5-8, a second embodiment holder 1′ is illustrated. Holder 1′ has a hollow or partially hollow body but includes a narrow opening 2′ at its upper end. Opening 2′ is of a size and shape to receive neck 11 of container 10, similar to holder 1 of the first embodiment. Opening 2′ may be defined by side walls 6, which further form hollow opening 5. At the bottom of opening 2′ is a connection or fitting 7 to fit a pneumatic sucker 8, or suction device such as calotte or a suction cup, as illustrated, having an elastic body 8 and a hard head 9 to which the suction device is fitted to holder 1′. Fitting of the sucker (suction cup) to the holder can be performed in several known ways.

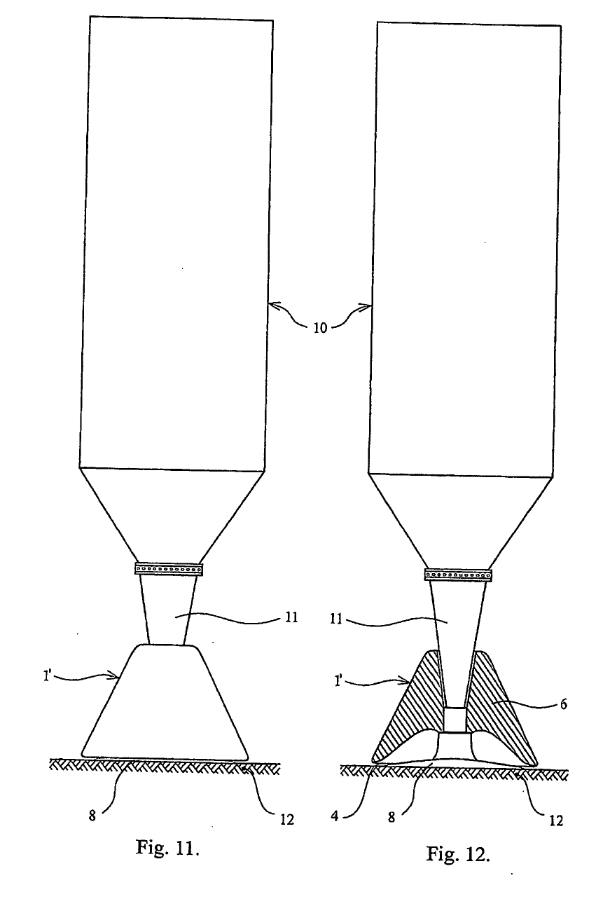

The suction cup elastic body 8 partly protrudes from below the holder, as illustrated in FIG. 6, so that it reaches base 12 before the side walls 6. By pressing the suction cup against base 12, as can be seen in FIGS. 11. and 12, the suction cup elastic body 8 spreads and pushes the air from under the cup and, thus, creates a vacuum to additionally fix holder 1′ to base 12. Moreover, side walls 6 also lean into the base, thereby preventing tilting of the container.

In use, the narrowed part of the container neck is inserted into the narrow openings 2 and 2′, so that neck 11 of container 10 is imbedded into holders 1, 1′. Before the first use of its contents, the container 10 is kept upright, neck up. Once the container has been opened, the container is flipped upside down in order to prevent drying and clogging. The container is kept available for frequent access to the viscous contents by inserting the neck of the container into opening 2, 2′ of holder 1, 1′, which has its bottom set directly onto base 12 or is suction fixed or sealed to base 12 via suction device 8.

The holder, being set upon base 12, functions as a closure to the container. In the first embodiment, the solid body forms a closure at the end of opening 2 such that the viscous contents cannot be removed from container 10 via neck 11 past the bottom of opening 2 (see FIG. 10). In the second embodiment, the closure is formed by the fitting or the top of the sucker/suction device or cap as illustrated in FIG. 12.

The container neck can be taken in and out of holders 1, 1′ many times. This is particularly practical for containers containing viscous matters, since leaving the container upside down prevents the air from entering the container and solidifying viscous content within the neck. Containers that are opened and left right side up do allow air to enter the container and often form clogs within the neck, even with classical taps.

Although the holders of the present invention are intended to contain viscous matter such as glue used in the cabinet-making industry, other containers of viscous matter are encompassed in the present invention. For example, the holders of the present invention may hold containers containing shampoo, washing agents, and toothpaste. Furthermore, the invention encompasses holders containing containers of various foodstuffs, such as honey, mayonnaise, yogurt, fruit syrups, and select dairy products. Likewise, the holders of the present invention can be utilized to hold containers containing medicines, such as liquid syrups.

Advantages of the present invention include the ability to contain viscous matter that can be removed/replaced in its holder multiple times with minimal risk of drying, solidifying, or clogging the viscous matter within the neck of the container. The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that his patent rights not be limited by the particular embodiments illustrated and described herein, but rather by the following claims interpreted according to accepted doctrines of claim interpretation, including the Doctrine of Equivalents and Reversal of Parts.

What is claimed is:

1. A holder for holding a container containing viscous fluid; the container having a neck; the holder comprising:
a body having an upper portion and a bottom portion;
an opening of a size and shape to accommodate at least a substantial portion of a neck of a container containing a viscous material being positioned within the upper portion of the body of the holder;
the bottom portion being of a size and shape to seat with a base when the container's neck is at least partially inserted into the holder opening and the container containing the viscous material is positioned upside down.

2. The holder according to claim 1 wherein the holder is made from a solid material with a bottom portion that is wider than the upper portion.

3. The holder according to claim 1 wherein the holder's bottom portion has a planar bottom.

4. The holder according to claim 2 wherein the holder's bottom portion has a planar bottom that is wider than the upper portion.

5. The holder according to claim 1 wherein the holder further includes a fitting attached to the body adjacent the bottom of the opening, the fitting to which a suction device is attached that has a size and shape to suction attach to the base.

6. The holder according to claim 5 wherein the suction device is a suction cup.

7. The holder according to claim 5 wherein a lower portion of the suction device extends beyond the bottom portion of the holder.

8. The holder according to claim 7 wherein the suction device is a suction cup.

9. A method of accessing an open container containing viscous material multiple times without allowing excess air into the container to dry or clog the contents, the method comprising:
providing a freshly open container containing a viscous material with the container having an upper neck;
providing a holder having an upper portion and a bottom portion; the upper portion including an opening of a size and shape to at least partially receive the neck of the container;
positioning the holder onto a base with the holder's bottom portion contacting and being seated with the base;
flipping the container upside down so that the viscous contents enter into the neck; and
positioning the neck of the container into the opening of the holder.

10. The method according to claim 9 wherein the holder is made from a solid material with a bottom portion that is wider than the upper portion.

11. The method according to claim 10 wherein the bottom portion includes a planar bottom surface that seats with the base.

12. The method according to claim 9 wherein the body further includes a fitting positioned at the bottom of the opening and forms a hollow opening to which a suction device is positioned and attached to the fitting and that the suction device is of a size and shape to suction attach to the base.

13. The method according to claim 12 wherein a lower portion of the suction device extends beyond the bottom portion of the holder.

14. The holder according to claim 13 wherein the suction device is a suction cup.

15. Holder of containers containing viscous matters, wherein the holder (1) contains of the body (3) made of a solid material, the bottom (4) by which it is fixed against the base (12), the opening (2) at its upper end, adjusted to the shape of the neck (11) of the container (10); the holder (1′) has the opening (2′) at its upper end, adjusted to the shape of the neck (11) of the container (10); the holder bottom part is a hollow body with the opening (5) between the side walls (6), containing the fitting (7) for connecting the head (9) of the pneumatic sucker head the elastic body (8) of which partly protrudes from below the holder, so that it reaches the base (12) before the side walls (6); when the container (10) is pressed against the base, the sucker elastic body spreads and pushes the air from below the sucker, and the thus created vacuum additionally fixes the holder against the base, at which moment the side walls (6), too, lean against the base thus preventing tilting of the container.
